(19) United States
(12) Patent Application Publication
(10) Pub. No.: US 2024/0078745 A1
(43) Pub. Date: Mar. 7, 2024

(54) GENERATION OF A VIRTUAL VIEWPOINT IMAGE OF A PERSON FROM A SINGLE CAPTURED IMAGE

(71) Applicant: Meta Platforms Technologies, LLC, Menlo Park, CA (US)

(72) Inventors: Nikolaos Sarafianos, Castro Valley, CA (US); Tony Tung, San Francisco, CA (US)

(21) Appl. No.: 18/506,004

(22) Filed: Nov. 9, 2023

Related U.S. Application Data
(63) Continuation of application No. PCT/GR2021/000061, filed on Oct. 8, 2021.

(51) Int. Cl. G06T 15/20; G06T 7/11; G06T 7/73; G06T 15/04

(52) U.S. Cl. CPC G06T 15/205; G06T 7/11; G06T 7/74; G06T 15/04; G06T 2207/10012; G06T 2207/20021; G06T 2207/20084; G06T 2207/30196

(57) ABSTRACT

In one embodiment, one or more computing systems may receive an image comprising pixels corresponding to a person captured by a camera from a camera viewpoint. The one or more computing systems may generate, based on the image, (1) a first body-surface mapping associated with the camera viewpoint, the first body-surface mapping indicates, for each of the pixels corresponding to the person, a corresponding location on a surface of a human body, and (2) a second body-surface mapping associated with a first virtual viewpoint different from the camera viewpoint. The one or more computing systems may generate a partial texture of the person by warping the pixels corresponding to the person based on the first body-surface mapping, the partial texture having incomplete texel information. The one or more computing systems may generate, based on the partial texture, a full texture of the person, the full texture having complete texel information.

### PRIORITY

This application is a continuation under 35 U.S.C. § 120 of International Patent Application No. PCT/GR2021/000061, filed 8 Oct. 2021, which are incorporated herein by reference.

### TECHNICAL FIELD

This disclosure generally relates to systems and methods of generating stereo pairs of images.

### BACKGROUND

Video is captured by a variety of devices. These devices are typically equipped with standard camera devices that capture a 2D video of a scene. To generate a 3D effect, stereoscopy may be used. Stereoscopy is a technique for creating or enhancing the illusion of depth in an image by means of stereopsis for binocular vision. Most stereoscopic methods present two offset images separately to the left and right eye of the viewer. These two-dimensional images are then combined in the brain to give the perception of 3D depth.

### SUMMARY OF PARTICULAR EMBODIMENTS

Disclosed herein are a variety of different ways of generating output images at different virtual views from a received image. A computing system may access a video comprising a plurality of frames containing images. One goal of the disclosed methods is to generate an output image at a virtual viewpoint different from a camera viewpoint of a camera that was used to capture an image without explicit 3D reconstruction. More specifically, the output image may be of a person at a virtual viewpoint different from a camera viewpoint. A standard camera may capture a video containing a plurality of images. In particular embodiments, to generate a corresponding plurality of images at a different virtual viewpoint, multiple neural networks may be used to process a 2D video of a human in motion. The video may comprise a plurality of frames including RGB images of the person. A computing system may process these images to generate the two videos corresponding to the two views of a human. The computing system may process these images to generate a mapping between the RGB pixels of each of the images to a 3D surface-based model of body part of the person. In order to generate the mapping, the computing system may use a mapping machine-learning model to process one of the RGB images to generate the mapping between pixels of the single RGB image to the 3D surface-based model of body part of the person. A machine-learning model may be used to refine the 3D surface-based model into a refined 3D surface-based model. The refined 3D surface-based model is then used to warp the single RGB image that was used to generate the 3D surface-based model to generate a texture of the person. The texture may then be used as an input to a full texture machine-learning model that generates a full-body UV texture from the partial texture generated by the warped RGB images. The full texture machine-learning model may be used to inpaint regions that are not seen or are self-occluded areas. As an example and not by way of limitation, if the partial texture generated by the warped RGB images have a partial texture of a person's hands, then the full texture machine-learning model may inpaint the region corresponding to the person's hands to generate a complete texture of the person's hands. After generating the full texture using the full texture machine-learning model, the computing system may then use a view generation machine-learning model to generate two different views of the person using the refined 3D surface-based model. That is, the view generation machine-learning model may generate a left eye refined 3D surface-based model and a right eye refined 3D surface-based model. The complete texture generated from the full texture machine-learning model may then be warped onto the left eye refined 3D surface-based model and the right eye refined 3D surface-based model. A neural renderer machine-learning model may then be applied to the warped left and right images to fill in missing pixel information to generate the stereo pair of images of the person. This method of generating a stereo pair of images and/or an image at a virtual viewpoint may be done without an explicit 3D reconstruction of the person.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example environment of an image capture system and a client system.

FIG. 2 illustrates an example process of generating a refined body-surface mapping.

FIGS. 3A-3B illustrate example inputs and outputs of the process of generating the refined body-surface mapping.

FIG. 4 illustrates an example process of generating a refined texture of a person.

FIG. 5 illustrates example inputs and outputs of the process of generating a refined texture of a person.

FIGS. 6A-6B illustrate an example process of generating output images at multiple virtual viewpoints.

FIG. 7 illustrates an example computing system.

FIG. 8 illustrates an example method for generating an output image at a virtual viewpoint.

FIG. 9 illustrates an example artificial reality system.

FIG. 10 illustrates an example network environment.

FIG. 11 illustrates an example computer system.

### DESCRIPTION OF EXAMPLE EMBODIMENTS

As more people adopt artificial reality systems, more people will begin to use artificial reality systems for a variety of reasons. Artificial reality may be embodied as one or more of an augmented reality, virtual reality, or mixed reality. When using artificial reality systems there may be several functions that may involve capturing images via cameras of the user and/or other users. As an example and not by way of limitation, in a virtual meeting room, it may be beneficial to see other users in the virtual meeting room. To see people in 3D with an artificial reality system, pairs of stereo images may be used to create a stereoscopic effect for the artificial reality system. In particular embodiments, each user/participant of the virtual meeting room may have a standard video camera that captures a real-world 2D video of the user in motion. In most cases, to create pairs of stereo images, the user would need to be reconstructed in 3D and then create two views of the user. However, reconstructing 3D people from images and/or videos is still very challenging. As such, a different approach may be needed to generate 2 views of a user from one 2D video of a user in motion without explicit 3D reconstruction of the observed user.

In particular embodiments, to generate two videos corresponding to the two views of a human from the single video, multiple neural networks may be used to process a 2D video of a human in motion. Initially, a video of a person may be captured by a standard video camera. The video may comprise a plurality of frames including RGB images of the person. A computing system may process these images to generate the two videos corresponding to the two views of a human. As an example and not by way of limitation, an artificial reality headset may process these images to generate a mapping between the RGB pixels of each of the images to a 3D surface-based model of body part of the person. In order to generate the mapping, the artificial reality headset may use a mapping machine-learning model to process one of the RGB images to generate the mapping between pixels of the single RGB image to the 3D surface-based model of body part of the person. A machine-learning model may be used to refine the 3D surface-based model into a refined 3D surface-based model. The refined 3D surface-based model is then used to warp the single RGB image that was used to generate the 3D surface-based model to generate a texture of the person. The texture may then be used as an input to a full texture machine-learning model that generates a full-body UV texture from the partial texture generated by the warped RGB images. The full texture machine-learning model may be used to inpaint regions that are not seen or are self-occluded areas. As an example and not by way of limitation, if the partial texture generated by the warped RGB images have a partial texture of a person's hands, then the full texture machine-learning model may inpaint the region corresponding to the person's hands to generate a complete texture of the person's hands. After generating the full texture using the full texture machine-learning model, the artificial reality headset may then use a view generation machine-learning model to generate two different views of the person using the refined 3D surface-based model. That is, the view generation machine-learning model may generate a left eye refined 3D surface-based model and a right eye refined 3D surface-based model. The complete texture generated from the full texture machine-learning model may then be warped onto the left eye refined 3D surface-based model and the right eye refined 3D surface-based model. A neural renderer machine-learning model may then be applied to the warped left and right images to fill in missing pixel information to generate the stereo pair of images of the person. This method of generating a stereo pair of images and/or an image at a virtual viewpoint may be done without an explicit 3D reconstruction of the person.

In particular embodiments, while an example of an artificial reality system is used to describe the process, the process may generally be done by any computing system that receives a video of a person. Additionally, in particular embodiments, monoscopic devices may take advantage of the stereo pair of images of a person that is generated from a single frame of a video. As an example and not by way of limitation, a computing system coupled to a monoscopic device (e.g., a PC monitor) may blend the pair of stereo images in a way that changes the view of the observed person based on the perspective a user is viewing the monoscopic device. For instance, if the user moves to the left of the monoscopic device, the user may see more of the side of the face of the person.

In particular embodiments, one or more computing systems may generate an output image of a person viewed from a virtual viewpoint. In particular embodiments, an artificial reality system may generate an output image of a person viewed from a virtual viewpoint. While this disclosure may describe an artificial reality system as performing one or more of the processes described herein, one or more other computing systems may perform the processes described herein. As an example and not by way of limitation, a smartphone may perform the processes described herein. In particular embodiments, one or more computing systems may receive an image comprising pixels corresponding to a person captured by a camera from a camera viewpoint. As an example and not by way of limitation, the one or more computing systems may receive a video of a person from a camera facing directly in front of the person. The video may comprise a plurality of frames that each comprises an image of the person. The camera may be coupled (wirelessly coupled) to another computing system and/or be configured to send the plurality of images captured by the camera to another computing system. For instance, the camera may send the plurality of images captured wirelessly to the one or more computing systems. In particular embodiments, the one or more computing systems may perform segmentation on the image to identify the pixels of the image that correspond to the person in the image. In particular embodiments, the one or more computing systems may generate a segmentation mask for the person that indicates which pixels of the image correspond to the person. Although this disclosure describes generating an output image of a person viewed from a virtual viewpoint in a particular manner, this disclosure contemplates generating an output image of a person viewed from a virtual viewpoint in any suitable manner.

In particular embodiments, the one or more computing systems may generate a body-surface mapping associated with the camera viewpoint. The body-surface mapping may indicate, for each pixel of an image corresponding to a person, a corresponding location on a surface of a human body. More specifically the body-surface mapping may indicate, for each pixel of the image corresponding to the person, a body part identifier and coordinates to a body surface of the person. As an example and not by way of limitation, the body-surface mapping may have an I-UV values for each pixel. The one or more computing systems may use an image of the observed person to generate the body-surface mapping. In particular embodiments, the one or more computing systems may use an initial body-surface mapping machine-learning model to generate an initial body-surface mapping associated with the camera viewpoint. In particular embodiments, the one or more computing systems may use a refined body-surface mapping machine-learning model to generate a refined body-surface mapping from the initial body-surface mapping by refining the initial body-surface mapping. In particular embodiments, the one or more computing systems may generate another body-surface mapping associated with a virtual viewpoint different from the camera viewpoint. As an example and not by way of limitation, if the camera viewpoint is facing a person directly, the virtual viewpoint may be five degrees to the right of the person. In particular embodiments, the one or more computing systems may use a view generation machine-learning model to generate a body-surface mapping associated with a virtual viewpoint different from a camera viewpoint associated with the image captured by the camera. The one or more computing systems may use the view generation machine-learning model to generate a plurality of body-surface mappings associated with a respective plurality of virtual viewpoints that are different from the camera viewpoint. As an example and not by way of limitation, the one or more computing systems may generate a first body-surface mapping that is five degrees to the right from the camera viewpoint and a second body-surface mapping that is five degrees to the left from the camera viewpoint. In particular embodiments, the view generation machine-learning model may generate body-surface mappings at a particular virtual viewpoint that is determined based on the user. As an example and not by way of limitation, the one or more computing systems may have a calibration process that determines which virtual viewpoints would be needed to generate a stereoscopic effect with a pair of stereo images. Although this disclosure describes generating a body-surface mapping in a particular manner, this disclosure contemplates generating a body-surface mapping in any suitable manner.

In particular embodiments, the one or more computing systems may generate a partial texture of the person in the image. In particular embodiments, the one or more computing systems may generate the partial texture by warping pixels corresponding to the person based on the body-surface mapping. As an example and not by way of limitations, the one or more computing systems may use the image from the camera and warp the pixels of the image corresponding to the pixels of the person based on the refined body-surface mapping to generate a partial texture. The partial texture may have incomplete texel information. In particular embodiments, the one or more computing systems may warp the pixels corresponding to the person based on the segmentation mask. As an example and not by way of limitation, the one or more computing systems may use both the refined body-surface mapping and the segmentation mask to generate the partial texture. Although this disclosure describes generating a partial texture in a particular manner, this disclosure contemplates generating a partial texture in any suitable manner.

In particular embodiments, the one or more computing systems may generate a full texture of a person. In particular embodiments, the one or more computing systems may generate the full texture of the person based on the partial texture. The full texture may have complete texel information. In particular embodiments, the one or more computing systems may use a full-texture machine-learning model to process the partial texture to generate the full texture. In particular embodiments, the partial texture may be an initial texture that is generated by the one or more computing systems and the full texture may be a refined texture generated by the one or more computing systems. The initial texture being refined by the full-texture machine-learning model to generate the refined texture. Although this disclosure describes generating a full texture in a particular manner, this disclosure contemplates generating a full texture in any suitable manner.

In particular embodiments, the one or more computing systems may generate an output image of a person as viewed from a virtual viewpoint. The one or more computing systems may use a full texture of the person and a body-surface mapping to generate the output image. As an example and not by way of limitation, the one or more computing systems may use a refined body-surface mapping that corresponds to the virtual viewpoint (e.g., the refined body-surface mapping as seen from a different angle corresponding to the virtual viewpoint) and the full texture to generate the output image. In particular embodiments, the one or more computing systems may generate a warped output image by warping the full texture based on a body-surface mapping. As an example and not by way of limitation, the one or more computing systems may generate a warped output image by warping the full texture based on the refined body-surface mapping. In particular embodiments, the one or more computing systems may apply a renderer machine-learning model to the warped output image to generate the output image. The renderer machine-learning model may fill in missing pixels of the warped output image to generate the output image. While this disclosure describes generating one output image, the one or more computing systems may generate a plurality of output images corresponding to a plurality of different virtual viewpoints. As an example and not by way of limitation, the one or more computing systems may generate an output image corresponding to a virtual viewpoint that is five degrees to the left of the camera viewpoint and another output image corresponding to a virtual viewpoint that is five degrees to the right of the camera viewpoint. Although this disclosure describes generating an output image of a person in a particular manner, this disclosure contemplates generating an output image of a person in any suitable manner.

In particular embodiments, the one or more computing systems may generate a pair of stereo images corresponding to the person. In particular embodiments, the one or more computing systems may generate a first output image that corresponds to a first virtual viewpoint (e.g., five degrees to the left of the camera viewpoint) and a second output image that corresponds to a second virtual viewpoint (e.g., five degrees to the right of the camera viewpoint). In particular embodiments, the one or more computing systems may combine the two output images to generate a pair of stereo images corresponding to the person. In particular embodiments, the one or more computing systems may send instructions to a client system associated with a user to present the pair of stereo images on a display to the user. As an example and not by way of limitation, the display may present a first stereo image to a first eye of the user and a second stereo image to a second eye of the user. For instance, the display may comprise two separate displays that are presented to each eye (e.g., an artificial reality headset). As another example and not by way of limitation, the pair of stereo images may be blended together to be presented on a display. When a user views the blended image from one viewpoint, the user may see a particular output image and the user may see another output image when the user views the blended image from another viewpoint. Although this disclosure describes generating a pair of stereo images in a particular manner, this disclosure contemplates generating a pair of stereo images in any suitable manner.

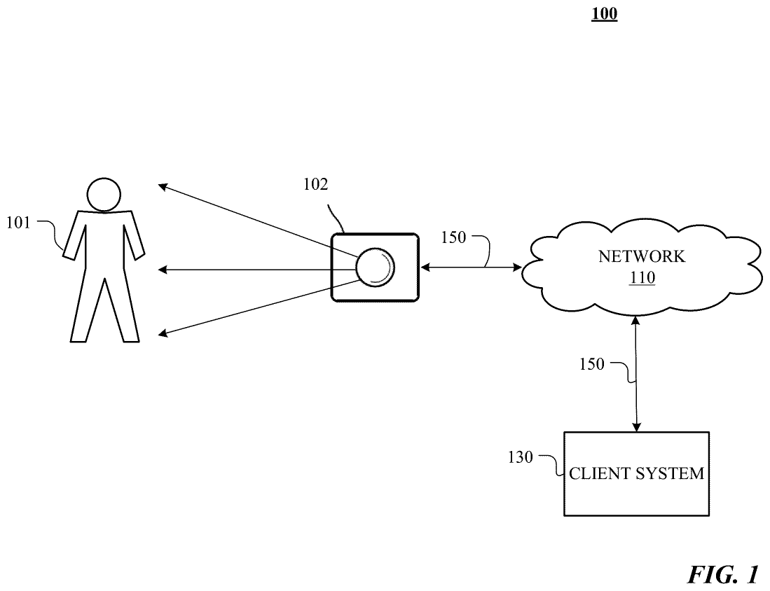

Referring to FIG. 1, an example environment 100 of an image capture system 102 and a client system 130 is shown. In particular embodiments, the example environment 100 may be used to generate output images at virtual viewpoints. In particular embodiments, the example environment 100 may comprise a user 101, an image capture system 102, and a client system 130, where the image capture system 102 and the client system 130 may be connected to each other by a network 110. Although FIG. 1 illustrates a particular arrangement of a user 101, image capture system 102, a client system 130, and a network 110, this disclosure contemplates any suitable arrangement of a user 101, image capture system 102, client system 130, and network 110. As an example and not by way of limitation, two or more of a user 101, image capture system 102, and client system 130 may be connected to each other directly, bypassing the network 110. As another example, the image capture system 102 and the client system 130 may be physically or logically co-located with each other in whole or in part. Moreover, although FIG. 1 illustrates a particular number of users 101, client systems 130, image capture systems 102, and networks 110, this disclosure contemplates any suitable number of users 101, client systems 130, image capture systems 102, and networks 110. As an example and not by way of limitation, the environment may include multiple users 101, client systems 130, image capture systems 102, and networks 110.

In particular embodiments, the image capture system 102 may be facing directly in front of a user 101 to capture a video of the user 101 in motion. In particular embodiments, the image capture system 102 may capture a plurality of frames of images. In particular embodiments, the image capture system 102 may be embodied as a camera system, a video camera, or any device that captures images and/or video. In particular embodiments, the image capture system 102 may be coupled (physically or wirelessly) to another client system 130. In particular embodiments, the image capture system 102 may be positioned in a camera viewpoint. As an example and not by way of limitation, the camera viewpoint may be directly in front of the user 101. In particular embodiments, the image capture system 102 may send the images captured and/or frames of a video to the client system 130 to process as described herein.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130 and an image capture system 102 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout an environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, artificial reality headset and controllers, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130. A client system 130 may generate an artificial reality environment for a user to interact with content.

In particular embodiments, two or more client systems 130 may be coupled to a respective image capture system 102 and a respective user 101. Each of the image capture systems 102 may capture a video of the respective user 101 and send the images captured to the other client system 130 to process as described herein. As an example and not by way of limitation, the client system 130 may generate a pair of output images from the received images as described herein. The pair of output images may generate a stereoscopic effect for the user 101 viewing the images so that the user 101 may see the other person in 3D. That way each user 101 may view each other in 3D. In particular embodiments, the user 101 may join a virtual meeting room where each user 101 may be presented in 3D as described herein. In particular embodiments, each client system 130 of the environment 100 may generate a blended image based on the pair of images to display on a monoscopic display as described herein.

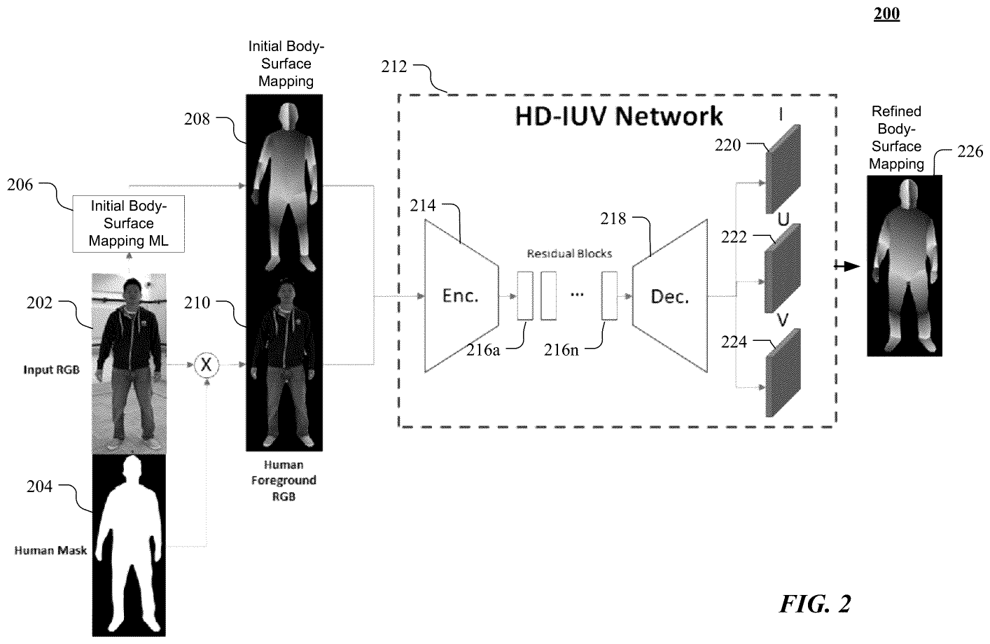

FIG. 2 illustrates an example process 200 of generating a refined body-surface mapping 226. In particular embodiments, the process 200 may be performed by one or more computing systems as described herein. As an example and not by way of limitation, the process 200 may be performed by an artificial reality system. In particular embodiments, the process 200 may begin with receiving a plurality of images containing pixels corresponding to a person. The process 200 may begin with an initial input RGB image 202. In particular embodiments, segmentation may be performed on the input RGB image 202 to generate a mask 204. In particular embodiments, the input RGB image 202 may be inputted into an initial body-surface mapping machine-learning model 206. The initial body-surface mapping machine-learning model 206 may generate an initial body-surface mapping 208 of the input RGB. In particular embodiments, the initial body-surface mapping 208 may indicate, for each pixel corresponding to the person, an identifier for body part, and a coordinate on a body surface. As an example and not by way of limitation, the identifier for body part may be determined from a body part index that comprises an identifier for 24 body parts (or any number of body parts). As another example and not by way of limitation, the coordinate on a body surface may be a UV coordinate. The initial body-surface mapping 208 may provide information to determine where a pixel maps to on a body surface. In particular embodiments, the initial body-surface mapping machine-learning model 206 may use depth measurements to generate the initial body-surface mapping 208. The process 200 may also generate a human foreground RGB input 210 based on the RGB image 202 and the mask 204. In particular embodiments, the initial body-surface mapping 208 and the human foreground RGB input 210 may be fed into a refined body-surface mapping machine-learning model 212. As an example and not by way of limitation, the refined body-surface mapping machine-learning model 212 may be an HD-IUV network. In particular embodiments, the refined body-surface mapping machine-learning model 212 may comprise an encoder 214, a plurality of residual blocks 216, a decoder 218, I-value 220, U-value 222, and V-value 224. In particular embodiments, the refined body-surface mapping machine-learning model 212 may include a plurality of downsampling building blocks, a plurality of residual blocks 216, a plurality of upsampling blocks with skip connections to pass information directly from the encoder 214 downsampling layers to the decoder 218 upsampling layers. The 3 output layers 220, 222, 224 comprising the I-value 220, U-value 222, and V-value 224 may be allocated a plurality of channels each in the refined body-surface mapping machine-learning model 212. In particular embodiments, the training data for the refined body-surface mapping machine-learning model 212 may comprise 3D scans of people in various poses. The 3D scans of people may be processed to obtain ground truth images. As an example and not by way of limitations, the 3D scans of people may be processed to generate ground truth refined body-surface mappings. 2D RGB images may be rendered from multiple views from the 3D scans of people to obtain initial body-surface mappings that are fed into the training data for the refined body-surface mapping machine-learning model 212. In particular embodiments, the output of the refined body-surface mapping machine-learning model 212 may be the refined body-surface mapping 226. In particular embodiments, one or more of the inputs/outputs of the process 200 may be stored on one or more computing systems to be accessed/processed later.

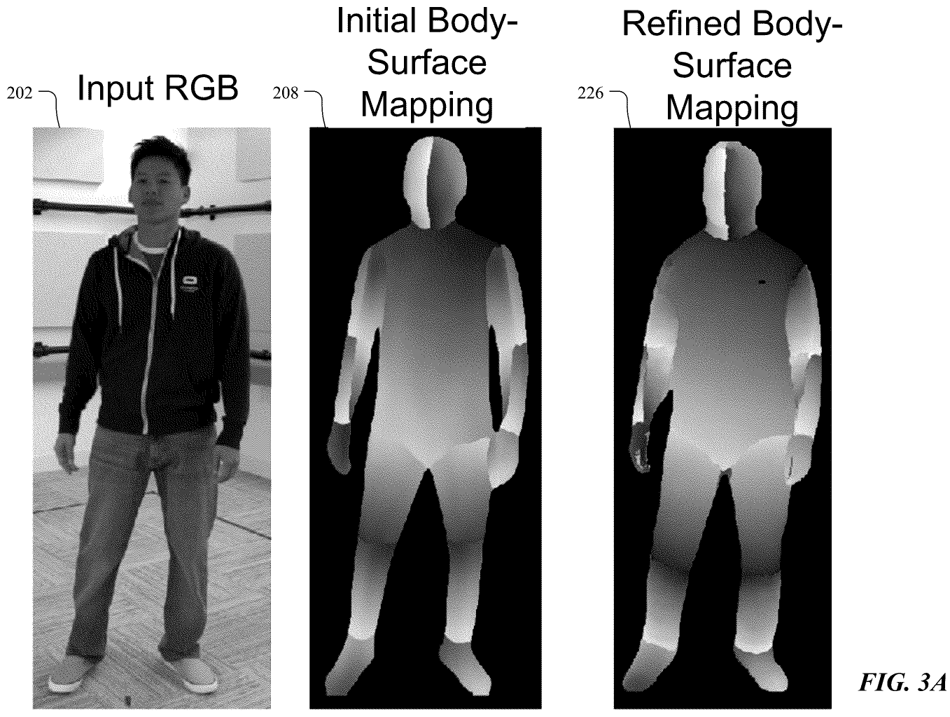

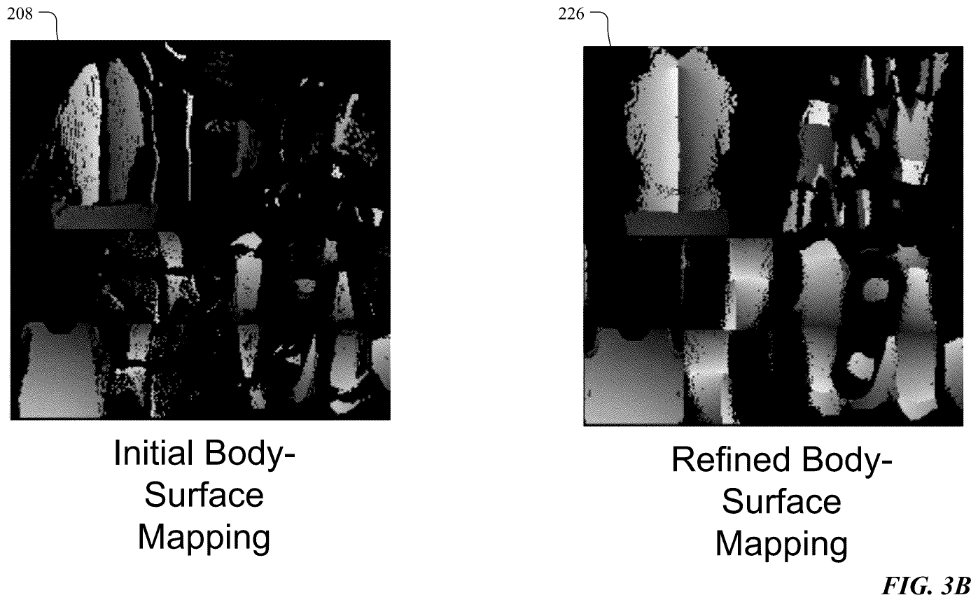

FIGS. 3A-3B illustrate example inputs and outputs of the process 200 of generating the refined body-surface mapping 226. Referring to FIG. 3A, an input RGB image 202 is shown for reference in comparison to an initial body-surface mapping 208 and a refined body-surface mapping 226. As shown, the initial body-surface mapping 208 may comprise an estimate body-surface mapping from the RGB image 202 and the refined body-surface mapping 226 may provide further information than the initial body-surface mapping 208. Referring to FIG. 3B, the initial body-surface mapping 208 is further separated to show the detail of the initial body-surface mapping 208 compared to the refined body-surface mapping 226. As shown in FIG. 3B, the refined body-surface mapping 226 may comprise more details than the initial body-surface mapping 208.

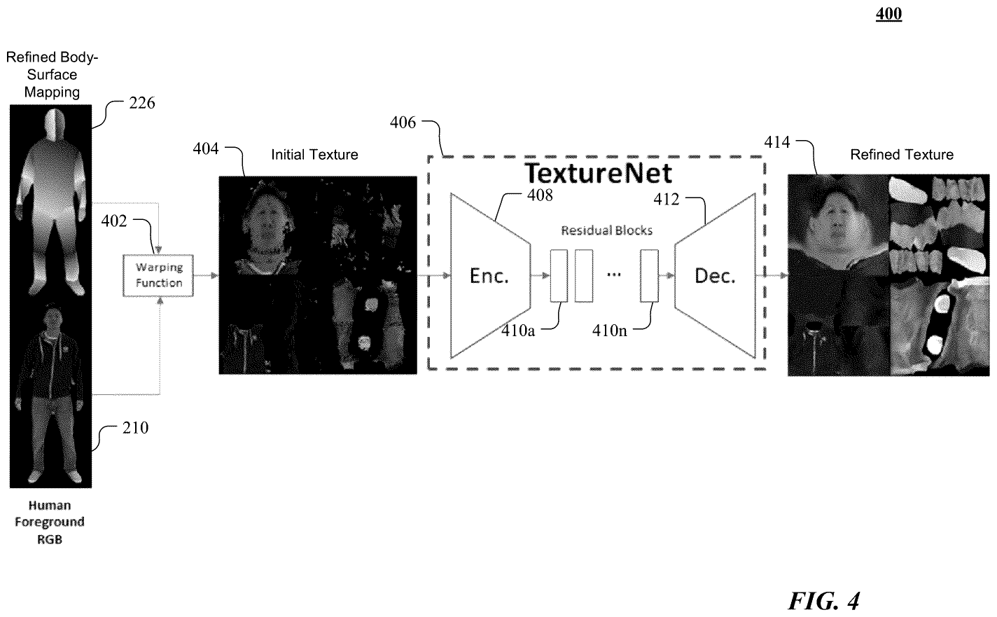

FIG. 4 illustrates an example process 400 of generating a refined texture 414. In particular embodiments, the process 400 may be performed by one or more computing systems as described herein. As an example and not by way of limitation, the process 400 may be performed by an artificial reality system. In particular embodiments, the process 400 may begin with receiving (or accessing) a refined body-surface mapping 226 and a human foreground RGB input 210. In particular embodiments, the process 400 may input the refined body-surface mapping 226 and the human foreground RGB input 210 into a warping function 402 to generate an initial texture 404. The warping function 402 may warp the human foreground RGB input 210 based on the refined body-surface mapping 226 to generate the initial texture 404. After the initial texture 404 is generated from the warping function 402, the initial texture 404 may be used as an input into a refined texture machine-learning model 406 or full texture machine-learning model 406. As an example and not by way of limitation, the refined texture machine-learning model 406 may be embodied as TextureNet. In particular embodiments, the refined texture machine-learning model 406 may comprise an encoder 408, a plurality of residual blocks 410, and a decoder 412. In particular embodiments, the refined texture machine-learning model 406 may comprise a plurality of downsampling building blocks, a plurality of residual blocks 410, a plurality of upsampling building blocks, and a plurality of skip connections to pass information directly from the encoder 408 downsampling layers to the decoder 412 upsampling layers. In particular embodiments, the training data of the refined texture machine-learning model 406 may be 3D scans of people in various poses. 2D RGB images may be rendered from multiple views based on the 3D scans of people in various poses. 2D texture images may be generated from partial views. The refined texture machine-learning model 406 may be trained with pairs of partial texture images and full texture images. In particular embodiments, the output of the refined texture machine-learning model 406 may be the refined texture 414. In particular embodiments, one or more of the inputs/outputs of the process 400 may be stored on one or more computing systems to be accessed/processed later.

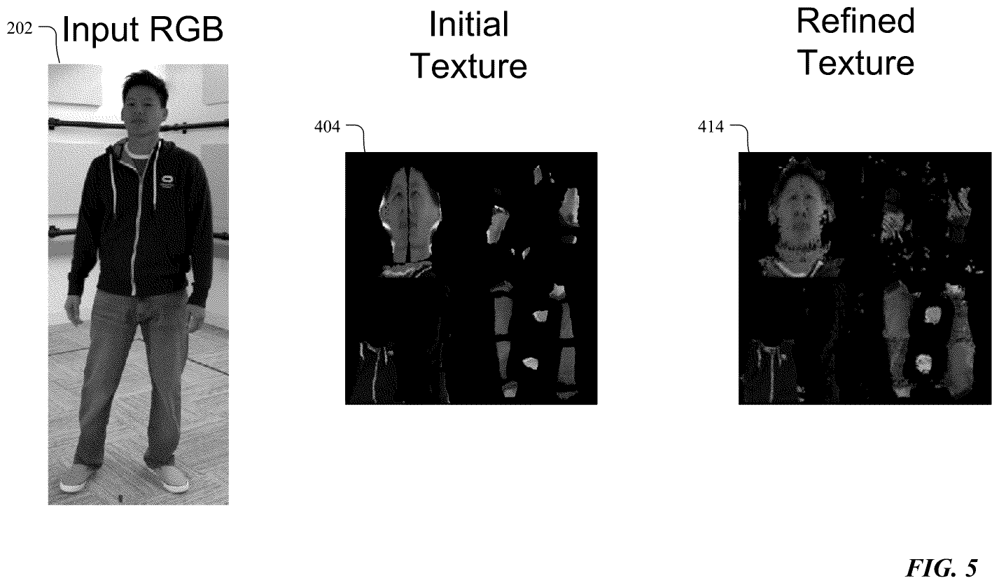

FIG. 5 illustrates example inputs and outputs of the process 400 of generating a refined texture 414. An input RGB image 202 is shown for reference in comparison to an initial texture 404 and refined texture 414. In particular embodiments, the initial texture 404 may be referred to as a partial texture. In particular embodiments, the refined texture 414 may be referred to as a full texture.

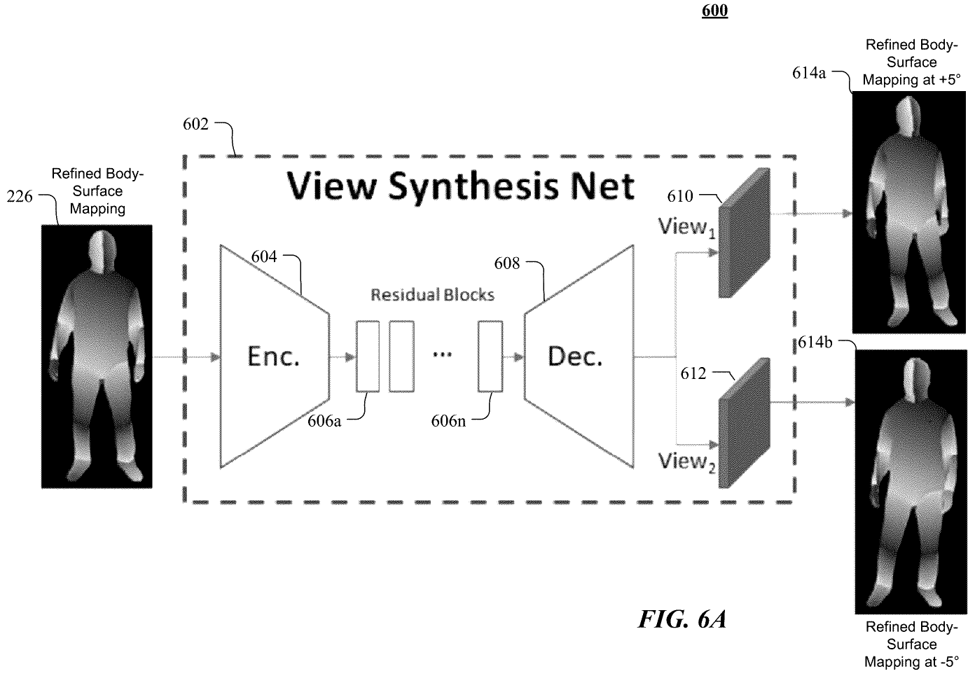

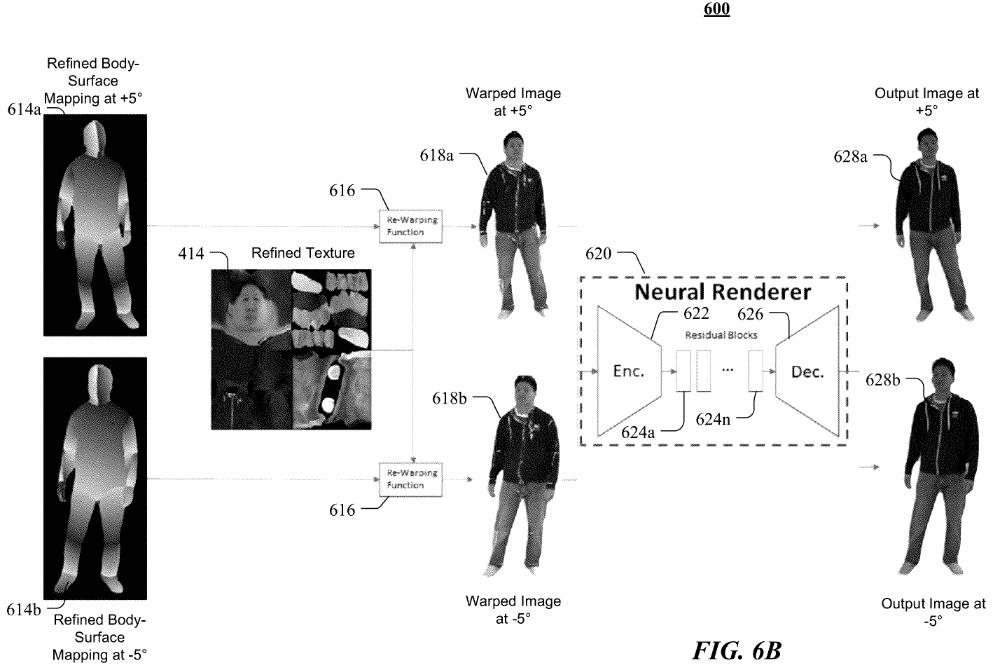

FIGS. 6A-6B illustrate an example process 600 of generating output images 628a, 628b at multiple virtual viewpoints. In particular embodiments, the process 600 may be performed by one or more computing systems as described herein. As an example and not by way of limitation, the process 600 may be performed by an artificial reality system. Referring to FIG. 6A, in particular embodiments, the process 600 may begin with accessing a refined body-surface mapping 226. The refined-body surface mapping 226 may be used as an input to a view generation machine-learning model 602. As an example and not by way of limitation, the view generation machine-learning model 602 may be embodied as a View Synthesis Net. In particular embodiments, the view generation machine-learning model 602 may include an encoder 604, a plurality of residual blocks 606, a decoder 608, a view 1 610, and a view 2 612. In particular embodiments, the view generation machine-learning model 602 may have a similar structure as the refined texture machine-learning model 406. The view generation machine-learning model 602 may have output layers 410, 412 that have a separate convolutional layer per desired view. As an example and not by way of limitation, if desired views include one that is 10 degrees to the right of a camera viewpoint and another that is five degrees to the left of the camera viewpoint, then the view generation machine-learning model 602 may have a separate convolutional layer for each of the desired views. In particular embodiments, the training data may comprise 3D scans of people. A refined body-surface mapping at a particular viewpoint may be generated and compared to a ground truth refined body-surface mapping at the particular viewpoint. The error between the two may be used to update the weights of the view generation machine-learning model 602. Although embodied as two separate machine-learning models, the refined body-surface mapping machine learning model 212 may perform the same functionality as the view generation machine-learning model 602. In particular embodiments, the output of the view generation machine-learning model 602 may be a refined body-surface mapping 614 at different virtual viewpoints. As an example and not by way of limitation, a refined body-surface mapping at five degrees to the right of the camera viewpoint 614a and a refined body-surface mapping at five degrees to the left of the camera viewpoint 614b are generated. Although a specific virtual viewpoint is shown (e.g., + and − five degrees), other virtual viewpoints may be used to generate a refined body-surface mapping at different virtual viewpoints 614. Referring to FIG. 6B, the refined body-surface mappings 614a, 614b at different viewpoints may be used in conjunction with a refined texture 414 to generate warped images 618a, 618b. In particular embodiments, the process 600 may use a re-warping function 616 to warp the refined texture 414 based on the refined body-surface mapping 614a and refined body-surface mapping 614b to generate warped images 618a, 618b corresponding to the virtual viewpoints that were used to generate the refined body-surface mappings 614. In particular embodiments, the re-warping function 616 may be the same as warping function 402. In particular embodiments, the warped images 618a, 618b may be used as an input into a renderer machine-learning model 620. As an example and not by way of limitation, the renderer machine-learning model 620 may be embodied as a neural renderer machine-learning model. In particular embodiments, the renderer machine-learning model 620 may comprise an encoder 622, a plurality of residual blocks 624, and a decoder 626. In particular embodiments, the renderer machine-learning model 620 may have similar structure as the refined texture machine-learning model 406. In particular embodiments, the training data of the renderer machine-learning model 620 may comprise 3D scans of people in various poses. 2D RGB images may be rendered from multiple views from the 3D scans. Refined body-surface mappings may be generated from front and side views. The renderer machine-learning model 620 may be trained with pairs of front and side views of the refined body-surface mappings. In particular embodiments, the output of the renderer machine-learning model 620 may be output images 628a, 628b. The output images 628a, 628b may be from the same virtual viewpoints as the refined body-surface mappings 614, 614b used to generate the output images 628a, 628b. Although output images 628a, 628b are shown to be outputs of the renderer machine-learning model 620, the renderer machine-learning model 620 may comprise a plurality of output images 628 at different virtual viewpoints. In particular embodiments, one or more of the inputs/outputs of the process 600 may be stored on one or more computing systems to be accessed/processed later.

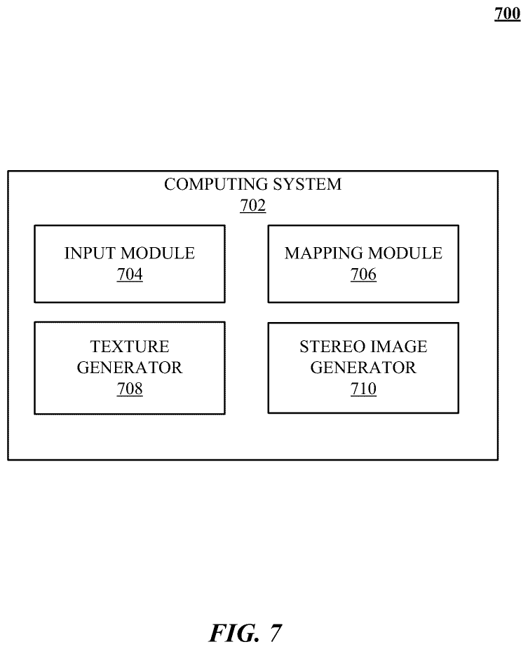

FIG. 7 illustrates an example computing system 702 of a computing environment 700. In particular embodiments, the computing system 702 may be embodied as an artificial reality system, a mobile device, a desktop, a server, and other computing systems as described herein. In particular embodiments, the computing system 702 may comprise an input module 704, a mapping module 706, a texture generator 708, and a stereo image generator 710. The computing system 702 may have similar or the same functionalities as the one or more computing systems described herein.

In particular embodiments, the input module 704 may interface one or more computing systems to receive a video comprising a plurality of frames containing images. As an example and not by way of limitation, the computing system 702 may interface an image capture system to receive a plurality of images as described herein. In particular embodiments, the input module 704 may interface a camera coupled to the computing system 702 to receive input data comprising a video comprising a plurality of frames containing images. As an example and not by way of limitation, the input module 704 may interface a camera to receive a video stream. As another example and not by way of limitation, the input module 704 may request a video from a computing system. As an example and not by way of limitation, the input module 704 may communicate with a server or a camera device to request a video comprising a plurality of frames containing images. In particular embodiments, the input module 704 may store the input data (e.g., a video) on the computing system 702. In particular embodiments, the input module 704 may be configured to process the input data to generate further input data. As an example and not by way of limitation, the input module 704 may perform segmentation on an image that is received to generate a mask for a person. For instance, the input module 704 may generate mask of a person from a received image. In particular embodiments, the input module 704 may generate a human foreground RGB input. The input module 704 may send the input data, such as an image, to other modules of the computing system 702. As an example and not by way of limitation, the input module 702 may send the input data to the mapping module 706 and texture generator 708.

In particular embodiments, the mapping module 706 may generate a body-surface mapping. In particular embodiments, the mapping module 706 may receive input data from the input module 704. In particular embodiments, the input data may comprise an RGB image and a human foreground RGB input. In particular embodiments, the mapping module 706 may use an initial body-surface mapping machine-learning model to generate an initial body-surface mapping form an RGB image. In particular embodiments, the mapping module 706 may use a refined body-surface mapping machine-learning model to generate a refined body-surface mapping from the initial body-surface mapping and the human foreground RGB input. In particular embodiments, the mapping module 706 may send the body-surface mappings to other modules of the computing system 702. As an example and not by way of limitation, the mapping module 706 may send the body-surface mappings to the texture generator 708 and the stereo image generator 710.

In particular embodiments, the texture generator 708 may generate textures of a person. In particular embodiments, the texture generator 708 may receive input data from the input module 704 and a body-surface mapping from the mapping module 706. In particular embodiments, the texture generator 708 may use a warping function to warp a human foreground RGB input based on a refined body-surface mapping to generate an initial texture. The texture generator 708 may use the initial texture as an input into a refined texture machine-learning model to generate a refined texture. In particular embodiments, the texture generator 708 may send the refined texture to other modules of the computing system 702. As an example and not by way of limitation, the texture generator 708 may send the refined texture to the stereo image generator 710.

In particular embodiments, the stereo image generator 710 may generate one or more output images at a virtual viewpoint. In particular embodiments, the stereo image generator 710 may receive inputs from the mapping module 706 and the texture generator 708. In particular embodiments, the stereo image generator 710 may use a refined body-surface mapping to input into a view generation machine-learning model to generate a refined body-surface mapping at different viewpoints. The refined body-surface mapping at different viewpoints may be inputted into a warping function with a refined texture to generate warped images at the different viewpoints. In particular embodiments, the warped images may be inputted into a renderer machine-learning model to generate output images at the same viewpoints as the warped images/refined body-surface mappings. In particular embodiments, the output images may be refined images of the warped images. In particular embodiments, the output images may be stored on the computing system 702. In particular embodiments, the combination of the output images at different virtual views may be combined to generate a pair of stereo images to be presented to a user of the computing system 702. In particular embodiments, the stereo images and/or output images at a virtual viewpoint may be sent to a display to present stereo images/output images to the user as described herein.

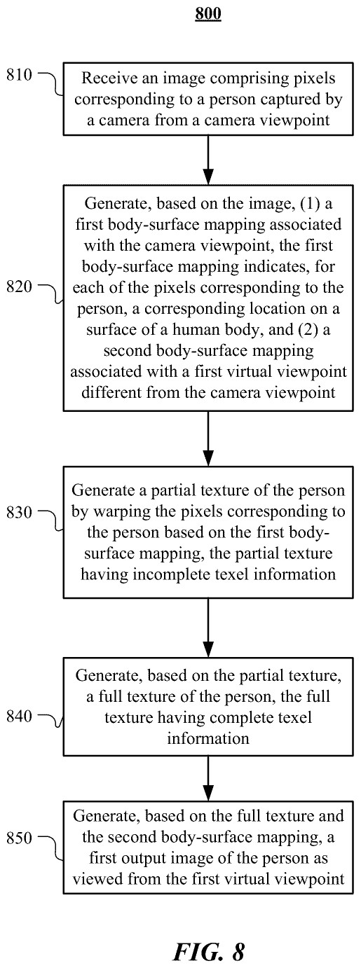

FIG. 8 illustrates an example method 800 for generating an output image at a virtual viewpoint. The method 800 may begin at step 810, where one or more computing systems may receive an image comprising pixels corresponding to a person captured by a camera from a camera viewpoint. In particular embodiments, the one or more computing systems may be embodied as an artificial reality system. As an example and not by way of limitation, the one or more computing systems may be embodied as a virtual reality headset system. At step 820, the one or more computing systems may generate, based on the image, (1) a first body-surface mapping associated with the camera viewpoint, the first body-surface mapping indicates, for each of the pixels corresponding to the person, a corresponding location on a surface of a human body, and (2) a second body-surface mapping associated with a first virtual viewpoint different from the camera viewpoint. At step 830, the one or more computing systems may generate a partial texture of the person by warping the pixels corresponding to the person based on the first body-surface mapping, where the partial texture may have incomplete texel information. At step 840, the one or more computing systems may generate, based on the partial texture, a full texture of the person, where the full texture may have complete texel information. At step 850, the one or more computing systems may generate, based on the full texture and the second body-surface mapping, a first output image of the person as viewed from the first virtual viewpoint. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for generating an output image at a virtual viewpoint, including the particular steps of the method of FIG. 8, this disclosure contemplates any suitable method of generating an output image at a virtual viewpoint, including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

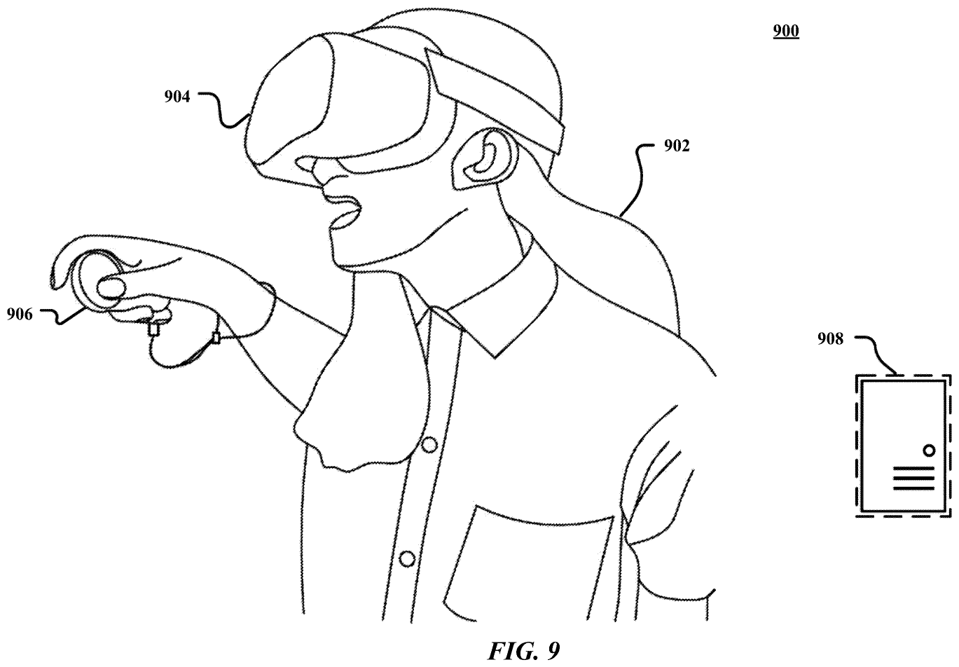

FIG. 9 illustrates an example artificial reality system 900. In particular embodiments, the artificial reality system 900 may comprise a headset 904, a controller 906, and a computing system 908. A user 902 may wear the headset 904 that may display visual artificial reality content to the user 902. The headset 904 may include an audio device that may provide audio artificial reality content to the user 902. As an example and not by way of limitation, the headset 904 may display visual artificial content and audio artificial reality content corresponding to a virtual meeting. The headset 904 may include one or more cameras which can capture images and videos of environments. The headset 904 may include a plurality of sensors to determine a head pose of the user 902. The headset 904 may include a microphone to receive audio input from the user 902. The headset 904 may be referred as a head-mounted display (HMD). The controller 906 may comprise a trackpad and one or more buttons. The controller 906 may receive inputs from the user 902 and relay the inputs to the computing system 908. The controller 906 may also provide haptic feedback to the user 902. The computing system 908 may be connected to the headset 904 and the controller 906 through cables or wireless connections. The computing system 908 may control the headset 904 and the controller 906 to provide the artificial reality content to and receive inputs from the user 902. The computing system 908 may be a standalone host computer system, an on-board computer system integrated with the headset 904, a mobile device, or any other hardware platform capable of providing artificial reality content to and receiving inputs from the user 902.

Although this disclosure describes and illustrates processes in context of a computing system performing various functions, another computing system (e.g., a server embodied as social-networking system 1060 or third-party system 1070) may handle the processing and send the results to the computing system.

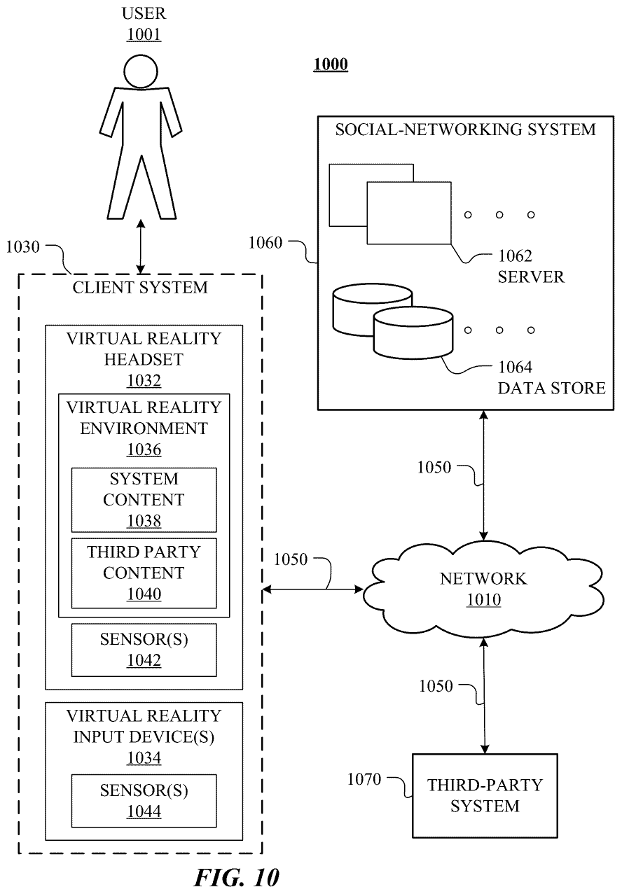

FIG. 10 illustrates an example network environment 1000 associated with a virtual reality system. Network environment 1000 includes a user 1001 interacting with a client system 1030, a social-networking system 1060, and a third-party system 1070 connected to each other by a network 1010. Although FIG. 10 illustrates a particular arrangement of a user 1001, a client system 1030, a social-networking system 1060, a third-party system 1070, and a network 1010, this disclosure contemplates any suitable arrangement of a user 1001, a client system 1030, a social-networking system 1060, a third-party system 1070, and a network 1010. As an example and not by way of limitation, two or more of a user 1001, a client system 1030, a social-networking system 1060, and a third-party system 1070 may be connected to each other directly, bypassing a network 1010. As another example, two or more of a client system 1030, a social-networking system 1060, and a third-party system 1070 may be physically or logically co-located with each other in whole or in part. Moreover, although FIG. 10 illustrates a particular number of users 1001, client systems 1030, social-networking systems 1060, third-party systems 1070, and networks 1010, this disclosure contemplates any suitable number of client systems 1030, social-networking systems 1060, third-party systems 1070, and networks 1010. As an example and not by way of limitation, network environment 1000 may include multiple users 1001, client systems 1030, social-networking systems 1060, third-party systems 1070, and networks 1010.

This disclosure contemplates any suitable network 1010. As an example and not by way of limitation, one or more portions of a network 1010 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 1010 may include one or more networks 1010.

Links 1050 may connect a client system 1030, a social-networking system 1060, and a third-party system 1070 to a communication network 1010 or to each other. This disclosure contemplates any suitable links 1050. In particular embodiments, one or more links 1050 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 1050 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1050, or a combination of two or more such links 1050. Links 1050 need not necessarily be the same throughout a network environment 1000. One or more first links 1050 may differ in one or more respects from one or more second links 1050.

In particular embodiments, a client system 1030 may be an electronic device including hardware, software, or embedded logic components or a combination of two or more such components and capable of carrying out the appropriate functionalities implemented or supported by a client system 1030. As an example and not by way of limitation, a client system 1030 may include a computer system such as a desktop computer, notebook or laptop computer, netbook, a tablet computer, e-book reader, GPS device, camera, personal digital assistant (PDA), handheld electronic device, cellular telephone, smartphone, virtual reality headset and controllers, other suitable electronic device, or any suitable combination thereof. This disclosure contemplates any suitable client systems 1030. A client system 1030 may enable a network user at a client system 1030 to access a network 1010. A client system 1030 may enable its user to communicate with other users at other client systems 1030. A client system 1030 may generate a virtual reality environment for a user to interact with content.

In particular embodiments, a client system 1030 may include a virtual reality (or augmented reality) headset 1032 and virtual reality input device(s) 1034, such as a virtual reality controller. A user at a client system 1030 may wear the virtual reality headset 1032 and use the virtual reality input device(s) to interact with a virtual reality environment 1036 generated by the virtual reality headset 1032. Although not shown, a client system 1030 may also include a separate processing computer and/or any other component of a virtual reality system. A virtual reality headset 1032 may generate a virtual reality environment 1036, which may include system content 1038 (including but not limited to the operating system), such as software or firmware updates and also include third-party content 1040, such as content from applications or dynamically downloaded from the Internet (e.g., web page content). A virtual reality headset 1032 may include sensor(s) 1042, such as accelerometers, gyroscopes, magnetometers to generate sensor data that tracks the location of the headset device 1032. The headset 1032 may also include eye trackers for tracking the position of the user's eyes or their viewing directions. The client system may use data from the sensor(s) 1042 to determine velocity, orientation, and gravitation forces with respect to the headset. Virtual reality input device(s) 1034 may include sensor(s) 1044, such as accelerometers, gyroscopes, magnetometers, and touch sensors to generate sensor data that tracks the location of the input device 1034 and the positions of the user's fingers. The client system 1030 may make use of outside-in tracking, in which a tracking camera (not shown) is placed external to the virtual reality headset 1032 and within the line of sight of the virtual reality headset 1032. In outside-in tracking, the tracking camera may track the location of the virtual reality headset 1032 (e.g., by tracking one or more infrared LED markers on the virtual reality headset 1032). Alternatively or additionally, the client system 1030 may make use of inside-out tracking, in which a tracking camera (not shown) may be placed on or within the virtual reality headset 1032 itself. In inside-out tracking, the tracking camera may capture images around it in the real world and may use the changing perspectives of the real world to determine its own position in space.

Third-party content 1040 may include a web browser and may have one or more add-ons, plug-ins, or other extensions. A user at a client system 1030 may enter a Uniform Resource Locator (URL) or other address directing a web browser to a particular server (such as server 1062, or a server associated with a third-party system 1070), and the web browser may generate a Hyper Text Transfer Protocol (HTTP) request and communicate the HTTP request to server. The server may accept the HTTP request and communicate to a client system 1030 one or more Hyper Text Markup Language (HTML) files responsive to the HTTP request. The client system 1030 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, the social-networking system 1060 may be a network-addressable computing system that can host an online social network. The social-networking system 1060 may generate, store, receive, and send social-networking data, such as, for example, user-profile data, concept-profile data, social-graph information, or other suitable data related to the online social network. The social-networking system 1060 may be accessed by the other components of network environment 1000 either directly or via a network 1010. As an example and not by way of limitation, a client system 1030 may access the social-networking system 1060 using a web browser of a third-party content 1040, or a native application associated with the social-networking system 1060 (e.g., a mobile social-networking application, a messaging application, another suitable application, or any combination thereof) either directly or via a network 1010. In particular embodiments, the social-networking system 1060 may include one or more servers 1062. Each server 1062 may be a unitary server or a distributed server spanning multiple computers or multiple datacenters. Servers 1062 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 1062 may include hardware, software, or embedded logic components or a combination of two or more such components for carrying out the appropriate functionalities implemented or supported by server 1062. In particular embodiments, the social-networking system 1060 may include one or more data stores 1064. Data stores 1064 may be used to store various types of information. In particular embodiments, the information stored in data stores 1064 may be organized according to specific data structures. In particular embodiments, each data store 1064 may be a relational, columnar, correlation, or other suitable database. Although this disclosure describes or illustrates particular types of databases, this disclosure contemplates any suitable types of databases. Particular embodiments may provide interfaces that enable a client system 1030, a social-networking system 1060, or a third-party system 1070 to manage, retrieve, modify, add, or delete, the information stored in data store 1064.

In particular embodiments, the social-networking system 1060 may store one or more social graphs in one or more data stores 1064. In particular embodiments, a social graph may include multiple nodes—which may include multiple user nodes (each corresponding to a particular user) or multiple concept nodes (each corresponding to a particular concept)—and multiple edges connecting the nodes. The social-networking system 1060 may provide users of the online social network the ability to communicate and interact with other users. In particular embodiments, users may join the online social network via the social-networking system 1060 and then add connections (e.g., relationships) to a number of other users of the social-networking system 1060 whom they want to be connected to. Herein, the term “friend” may refer to any other user of the social-networking system 1060 with whom a user has formed a connection, association, or relationship via the social-networking system 1060.

In particular embodiments, the social-networking system 1060 may provide users with the ability to take actions on various types of items or objects, supported by the social-networking system 1060. As an example and not by way of limitation, the items and objects may include groups or social networks to which users of the social-networking system 1060 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 1060 or by an external system of a third-party system 1070, which is separate from the social-networking system 1060 and coupled to the social-networking system 1060 via a network 1010.

In particular embodiments, the social-networking system 1060 may be capable of linking a variety of entities. As an example and not by way of limitation, the social-networking system 1060 may enable users to interact with each other as well as receive content from third-party systems 1070 or other entities, or to allow users to interact with these entities through an application programming interfaces (API) or other communication channels.

In particular embodiments, a third-party system 1070 may include one or more types of servers, one or more data stores, one or more interfaces, including but not limited to APIs, one or more web services, one or more content sources, one or more networks, or any other suitable components, e.g., that servers may communicate with. A third-party system 1070 may be operated by a different entity from an entity operating the social-networking system 1060. In particular embodiments, however, the social-networking system 1060 and third-party systems 1070 may operate in conjunction with each other to provide social-networking services to users of the social-networking system 1060 or third-party systems 1070. In this sense, the social-networking system 1060 may provide a platform, or backbone, which other systems, such as third-party systems 1070, may use to provide social-networking services and functionality to users across the Internet.

In particular embodiments, a third-party system 1070 may include a third-party content object provider. A third-party content object provider may include one or more sources of content objects, which may be communicated to a client system 1030. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 1060 also includes user-generated content objects, which may enhance a user's interactions with the social-networking system 1060. User-generated content may include anything a user can add, upload, send, or “post” to the social-networking system 1060. As an example and not by way of limitation, a user communicates posts to the social-networking system 1060 from a client system 1030. Posts may include data such as status updates or other textual data, location information, photos, videos, links, music or other similar data or media. Content may also be added to the social-networking system 1060 by a third-party through a “communication channel,” such as a newsfeed or stream.

In particular embodiments, the social-networking system 1060 may include a variety of servers, sub-systems, programs, modules, logs, and data stores. In particular embodiments, the social-networking system 1060 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 1060 may also include suitable components such as network interfaces, security mechanisms, load balancers, failover servers, management-and-network-operations consoles, other suitable components, or any suitable combination thereof. In particular embodiments, the social-networking system 1060 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 1060 to one or more client systems 1030 or one or more third-party systems 1070 via a network 1010. The web server may include a mail server or other messaging functionality for receiving and routing messages between the social-networking system 1060 and one or more client systems 1030. An API-request server may allow a third-party system 1070 to access information from the social-networking system 1060 by calling one or more APIs. An action logger may be used to receive communications from a web server about a user's actions on or off the social-networking system 1060. In conjunction with the action log, a third-party-content-object log may be maintained of user exposures to third-party-content objects. A notification controller may provide information regarding content objects to a client system 1030. Information may be pushed to a client system 1030 as notifications, or information may be pulled from a client system 1030 responsive to a request received from a client system 1030. Authorization servers may be used to enforce one or more privacy settings of the users of the social-networking system 1060. A privacy setting of a user determines how particular information associated with a user can be shared. The authorization server may allow users to opt in to or opt out of having their actions logged by the social-networking system 1060 or shared with other systems (e.g., a third-party system 1070), such as, for example, by setting appropriate privacy settings. Third-party-content-object stores may be used to store content objects received from third parties, such as a third-party system 1070. Location stores may be used for storing location information received from client systems 1030 associated with users. Advertisement-pricing modules may combine social information, the current time, location information, or other suitable information to provide relevant advertisements, in the form of notifications, to a user.

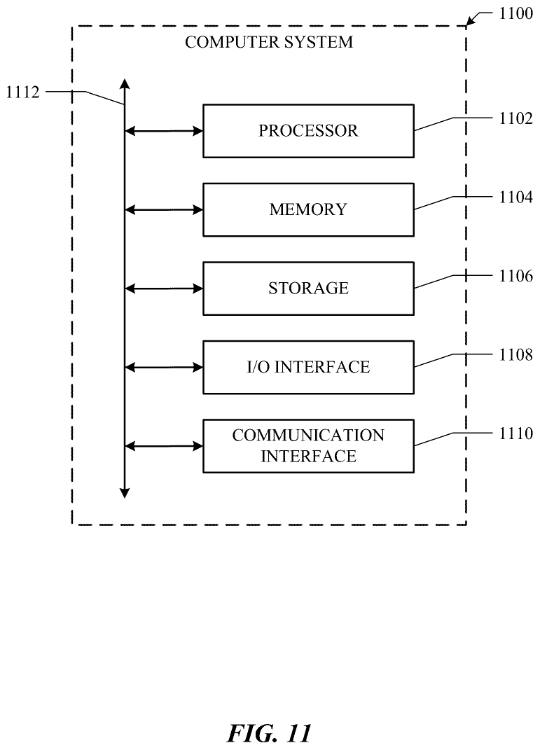

FIG. 11 illustrates an example computer system 1100. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
receiving an image comprising pixels corresponding to a person captured by a camera from a camera viewpoint;
generating, based on the image, (1) a first body-surface mapping associated with the camera viewpoint, the first body-surface mapping indicates, for each of the pixels corresponding to the person, a corresponding location on a surface of a human body, and (2) a second body-surface mapping associated with a first virtual viewpoint different from the camera viewpoint;
generating a partial texture of the person by warping the pixels corresponding to the person based on the first body-surface mapping, the partial texture having incomplete texel information;
generating, based on the partial texture, a full texture of the person, the full texture having complete texel information;
and generating, based on the full texture and the second body-surface mapping, a first output image of the person as viewed from the first virtual viewpoint.

2. The method of claim 1, further comprising:
performing segmentation on the image to identify the pixels corresponding to the person; and
generating a segmentation mask for the person that indicates which pixels of the image correspond to the person.

3. The method of claim 2, wherein warping the pixels corresponding to the person is further based on the segmentation mask.

4. The method of claim 1, wherein generating the first body-surface mapping associated with the camera viewpoint further comprises:
generating, using an initial body-surface mapping machine-learning model, a third body-surface mapping associated with the camera viewpoint; and
refining, using a refined body-surface mapping machine-learning model, the third body-surface mapping to generate the first body-surface mapping.

5. The method of claim 1, further comprising:
generating, based on the image, a third body-surface mapping associated with a second virtual viewpoint different from both of the camera viewpoint and the first virtual viewpoint.

6. The method of claim 5, further comprising:
generating, based on the full texture and the third body-surface mapping, a second output image of the person as viewed from the second virtual viewpoint.

7. The method of claim 6, further comprising:
generating, based on the first output image and the second output image, a pair of stereo images corresponding to the person.

8. The method of claim 7, further comprising:
presenting the pair of stereo images through a display to a first user, wherein the display presents a first stereo image to a first eye of the first user and a second stereo image to a second eye of the first user.

9. The method of claim 1, wherein generating the full texture of the person further comprises:
applying a full-texture machine-learning model to the partial texture to generate the full texture having complete texel information.

10. The method of claim 1, wherein generating the first output image further comprises:
generating a first warped output image by warping the full texture based on the first body-surface mapping; and
applying a renderer machine-learning model to the first warped output image to generate the first output image.

11. The method of claim 1, wherein the first body-surface mapping indicates, for each pixel of the image corresponding to the person, a body part identifier and coordinates to a body surface of the person.

12. One or more computer-readable non-transitory storage media embodying software that is operable when executed to:
receive an image comprising pixels corresponding to a person captured by a camera from a camera viewpoint;
generate, based on the image, (1) a first body-surface mapping associated with the camera viewpoint, the first body-surface mapping indicates, for each of the pixels corresponding to the person, a corresponding location on a surface of a human body, and (2) a second body-surface mapping associated with a first virtual viewpoint different from the camera viewpoint;
generate a partial texture of the person by warping the pixels corresponding to the person based on the first body-surface mapping, the partial texture having incomplete texel information;
generate, based on the partial texture, a full texture of the person, the full texture having complete texel information; and
generate, based on the full texture and the second body-surface mapping, a first output image of the person as viewed from the first virtual viewpoint.

13. The media of claim 12, wherein the one or more computer-readable non-transitory storage media is further operable when executed to:
generate, using an initial body-surface mapping machine-learning model, a third body-surface mapping associated with the camera viewpoint; and
refine, using a refined body-surface mapping machine-learning model, the third body-surface mapping to generate the first body-surface mapping.

14. The media of claim 12, wherein the one or more computer-readable non-transitory storage media is further operable when executed to:
generate, based on the image, a third body-surface mapping associated with a second virtual viewpoint different from both of the camera viewpoint and the first virtual viewpoint; and
generate, based on the full texture and the third body-surface mapping, a second output image of the person as viewed from the second virtual viewpoint.

15. The media of claim 14, wherein the one or more computer-readable non-transitory storage media is further operable when executed to:
generate, based on the first output image and the second output image, a pair of stereo images corresponding to the person.

16. The media of claim 15, wherein the one or more computer-readable non-transitory storage media is further operable when executed to:
present the pair of stereo images through a display to a first user, wherein the display presents a first stereo image to a first eye of the first user and a second stereo image to a second eye of the first user.

17. A system comprising:
one or more processors; and
one or more computer-readable non-transitory storage media coupled to one or more of the processors and comprising instructions operable when executed by one or more of the processors to cause the system to:
receive an image comprising pixels corresponding to a person captured by a camera from a camera viewpoint;
generate, based on the image, (1) a first body-surface mapping associated with the camera viewpoint, the first body-surface mapping indicates, for each of the pixels corresponding to the person, a corresponding location on a surface of a human body, and (2) a second body-surface mapping associated with a first virtual viewpoint different from the camera viewpoint;
generate a partial texture of the person by warping the pixels corresponding to the person based on the first body-surface mapping, the partial texture having incomplete texel information;
generate, based on the partial texture, a full texture of the person, the full texture having complete texel information; and
generate, based on the full texture and the second body-surface mapping, a first output image of the person as viewed from the first virtual viewpoint.

18. The system of claim 15, wherein the instructions are further executable by the one or more processors to:
generate, based on the image, a third body-surface mapping associated with a second virtual viewpoint different from both of the camera viewpoint and the first virtual viewpoint; and
generate, based on the full texture and the third body-surface mapping, a second output image of the person as viewed from the second virtual viewpoint.

19. The system of claim 15, wherein the instructions are further executable by the one or more processors to:
generate, based on the first output image and the second output image, a pair of stereo images corresponding to the person.

20. The system of claim 15, wherein the instructions are further executable by the one or more processors to:
present the pair of stereo images through a display to a first user, wherein the display presents a first stereo image to a first eye of the first user and a second stereo image to a second eye of the first user.
